(19) United States
(12) Patent Application Publication
(10) Pub. No.: US 2026/0338269 A1
(43) Pub. Date: Oct. 29, 2026

(54) Floating Male-Rotor Hypocycloidal Motor

(71) Applicant: Jialin DONG, Newport Beach, CA (US)

(72) Inventor: Jialin DONG, Newport Beach, CA (US)

(21) Appl. No.: 19/188,060

(22) Filed: Apr. 24, 2025

(51) Int. Cl. F16H 57/04; H02K 5/10

(52) U.S. Cl. CPC F16H 57/043; H02K 5/10

(57) ABSTRACT

A floating male-rotor hypocycloidal motor, comprising a floating stator arranged and working together with inner rollers, outer rollers, a rotor and an oil supply structure to change the oil pressure distribution in a first gap; and limited by the outer rollers, the floating stator deflects and swings to push the inner rollers on an inner side of the floating stator, the inner rollers, when pushed, drive the rotor to rotate, and finally, an output shaft rotates to output a large torque. In addition, the floating stator deflects eccentrically to allow the rotor to move around the axis, such that structures such as a sensor and a reducer may be easily integrated at a shaft end for the rotor and the output shaft.

### TECHNICAL FIELD

The invention relates to the technical field of motors, in particular to a floating male-rotor hypocycloidal motor.

### BACKGROUND

Traditional motors are often driven electrically, and an electric coil rotates under the action of a force in a magnetic field to drive a rotor to rotate to output a torque. Because the torque output by traditional electrically-driven motors is generally small, a reducer is configured to increase the output torque at the cost of reducing the speed, such as contents disclosed by Patent Publication No. CN119664857A and Patent Publication No. CN118881716A. However, because a speed reduction structure, such as a cycloidal speed reduction structure, needs to be additionally arranged outside an existing motor to increase the torque, the use of the motor and the cycloidal speed reduction structure makes the whole transmission structure and the connection relation more complex; in addition, with the increase in the number of transmission parts, the transmission loss will be increased accordingly, thus reducing the transmission efficiency; moreover, an eccentric output shaft is often arranged in a traditional cycloidal structure and cannot be directly connected to a subsequent structure, so a spline shaft needs to be arranged additionally to connect the eccentric output shaft to the subsequent structure. In view of this, a floating male-rotor hypocycloidal motor with high transmission efficiency and a large torque is needed.

### SUMMARY

To overcome the defects in the prior art, the invention provides a floating male-rotor hypocycloidal motor.

To solve the abovementioned problems, the invention adopts the following technical solution:

A floating male-rotor hypocycloidal motor includes an output shaft and a housing, wherein the output shaft is arranged in the housing and has an end stretching out of the housing; the floating male-rotor hypocycloidal motor further includes a hypocycloidal structure and an oil supply structure; the hypocycloidal structure includes a rotor, a floating stator, outer rollers and inner rollers; the rotor is in transmission connection with the output shaft and used for driving the output shaft to rotate, and a plurality of first grooves matched with the inner rollers are formed in an outer side of the rotor and allow the inner rollers to be inlaid therein; the floating stator is located on the outer side of the rotor; the floating stator is ring-shaped on the whole, up-and-down arc surfaces based on a cycloidal contour are arranged on an inner side of the floating stator, a cylindrical surface is arranged on an outer side of the floating stator, and second grooves corresponding to the outer rollers are formed in the outer side of the floating stator; the housing is located on an outer side of the hypocycloidal structure, third grooves matched with the outer rollers are formed in a side, close to the hypocycloidal structure, of the housing, and the outer rollers are inlaid in the third grooves; a minimum inner diameter of the floating stator is greater than an outer diameter of the rotor, and a first gap is formed between the floating stator and the rotor; a maximum outer diameter of the floating stator is less than an inner diameter of the housing, and a second gap is formed between the floating stator and the housing; and the oil supply structure corresponds to the first gap and is used for supplying oil into the first gap and pumping oil from the first gap.

Further, the oil supply structure includes a rear end cover, an oil distribution disc and an oil inlet and outlet disc; first oil holes and second oil holes are formed in the oil distribution disc and penetrate through the oil distribution disc, and the first oil holes and the second oil holes are respectively located on circular trajectories, with different radii, on the oil distribution disc; the first oil holes and the second oil holes in the oil distribution disc are arranged alternately; oil flows in via the first oil holes and flows out via the second oil holes, or oil flows in via the second oil holes and flows out via the first oil holes; a first oil groove corresponding to the first oil holes and a second oil groove corresponding to the second oil holes are formed in a side, close to the rear end cover, of the oil distribution disc, all the first oil holes are connected to the first oil groove, and all the second oil holes are connected to the second oil groove; the oil distribution disc is fixed and attached to the rear end cover, a first passage and a second passage are formed in the rear end cover, and the first passage and the second passage respectively correspond to the first oil groove and the second oil groove in the oil distribution disc; the oil inlet and outlet disc is attached to the floating stator and is in transmission connection with the rotor or the output shaft; oil inlet and outlet holes, the number of which corresponds to the number of the inner rollers, are formed in the oil inlet and outlet disc, and each of the oil inlet and outlet holes is located between two adjacent inner rollers; and when the oil inlet and outlet disc rotates with respect to the oil distribution disc, the oil inlet and outlet holes in the oil inlet and outlet disc are sequentially connected to the first oil holes and the second oil holes in the oil distribution disc.

Further, oil distribution cavities which are concaved downward are formed in sides, close to the oil inlet and outlet disc, of the first oil holes and the second oil holes in the oil distribution disc.

Further, a first positioning pin used for determining a matching angle between the oil distribution disc and the rear end cover is arranged between the oil distribution disc and the rear end cover.

Further, the number of the first oil holes formed in the oil distribution disc and the number of the second oil holes formed in the oil distribution disc are greater than the number of the inner rollers.

Further, oil storage cavities are respectively formed in two ends of the oil inlet and outlet holes in the oil inlet and outlet disc, and the oil storage cavities are connected to the oil inlet and outlet holes.

Further, the floating male-rotor hypocycloidal motor further includes a front end cover, the front end cover is fixedly connected to the housing by means of long screws, and a front abrasion-resistant disc used for sealing is fixedly arranged between the front end cover and the housing.

Further, second positioning pins used for determining matching angles are arranged between the housing and the front abrasion-resistant disc as well as between the housing and the front end cover.

Further, the floating male-rotor hypocycloidal motor further includes a brake structure; the brake structure includes a brake cover, a brake piston and a brake shaft, one end of the brake shaft is inserted into a central hole of the rear end cover to be in transmission connection with the output shaft, and the brake shaft seals the central hole of the rear end cover; the other end of the brake shaft penetrates into a brake hole in a middle of the brake piston and seals the brake piston; a plurality of protruding brake blocks are arranged on a periphery of the brake shaft and abut against an edge of the brake hole of the brake piston; the brake cover is fixedly connected to the rear end cover, and a plurality of disc springs are arranged between the brake cover and the brake piston; and the brake piston is slidably arranged in a columnar cavity in the rear end cover, and a brake oil hole used for supplying and pumping oil is formed in the columnar cavity.

Further, an oil supply hole corresponding to the second gap and used for lubricating the outer rollers is formed in the rear end cover.

The invention has the following beneficial effects:

The floating stator is arranged and works together with the inner rollers, the outer rollers, the rotor and the oil supply structure to change the oil pressure distribution in the first gap, such that the floating stator is driven to deflect and swing to drive the rotor therein to rotate so as to control the output shaft to rotate to output a large torque; in addition, the floating stator allows the rotor to move around the axis, such that structures such as a sensor and a reducer may be easily integrated at a shaft end for the rotor and the output shaft; the oil distribution disc and the oil inlet and outlet disc are arranged to supply oil into the first gap and pump oil from the first oil gap to control the oil pressure distribution in the first gap so as to control the rotor to rotate; the brake structure is arranged and works together with the brake oil hole to control the relative pressure between the brake piston and the brake shaft to adjust the brake force and even control the brake shaft and the output shaft to stop; the oil distribution cavities are arranged, on one hand, the oil distribution cavities may be easily connected to the oil inlet and outlet holes in the oil inlet and outlet disc within a greater angle range; on the other hand, a certain quantity of hydraulic oil may be stored in the oil distribution cavities, such that when the oil distribution cavities are connected to the oil inlet and outlet holes in the oil inlet and outlet disc, hydraulic oil may be quickly filled into the first gap by means of the oil inlet and outlet holes, thus increasing the rotational speed and torque output by the output shaft.

### BRIEF DESCRIPTION OF THE DRAWINGS

FIG. 1 is an overall structural view according to Embodiment 1;

FIG. 2 is an overall exploded structural view according to Embodiment 1;

FIG. 3 is an overall exploded structural view from another perspective according to Embodiment 1;

FIG. 4 is an overall front structural view according to Embodiment 1;

FIG. 5 is a sectional view along A-A in FIG. 4;

FIG. 6 is a cooperation diagram of a hypocycloidal structure according to Embodiment 1;

FIG. 7 is a schematic diagram of a rear end cover according to Embodiment 1;

FIG. 8 is a schematic diagram of the rear end cover from another perspective according to Embodiment 1;

FIG. 9 is a schematic diagram of an oil inlet and outlet disc according to Embodiment 1;

FIG. 10 is a schematic diagram of the oil inlet and outlet disc from another perspective according to Embodiment 1;

FIG. 11 is a schematic diagram of an oil distribution disc according to Embodiment 1;

FIG. 12 is a schematic diagram of the oil distribution disc from another perspective according to Embodiment 1;

FIG. 13 is an exploded view of a brake structure in a state where a brake cover is removed according to Embodiment 1.

Reference signs: 1, output shaft; 11, tooth structure; 2, housing; 21, second positioning pin; 3, hypocycloidal structure; 31, rotor; 32, floating stator; 33, outer roller; 34, inner roller; 35, first groove; 36, second groove; 37, third groove; 38, first gap; 39, second gap; 4, oil supply structure; 41, rear end cover; 411, first passage; 412, second passage; 413, first positioning pin; 414, columnar cavity; 415, brake oil hole; 416, oil supply hole; 417, first arc hole; 418, second arc hole; 42, oil distribution disc; 421, first oil hole; 422, second oil hole; 423, first oil groove; 424, second oil groove; 425, oil distribution cavity; 43, oil inlet and outlet disc; 431, oil inlet and outlet hole; 432, oil storage cavity; 5, front end cover; 51, front abrasion-resistant disc; 6, brake structure; 61, brake cover; 62, brake piston; 621, brake hole; 63, brake shaft; 64, disc spring; 65, brake pillar; 66, brake compression ring.

### DETAILED DESCRIPTION OF THE EMBODIMENTS

The embodiments of the invention are described below in conjunction with a specific example, and those skilled in the art may easily understand other advantages and effects of the invention with reference to the contents disclosed here. The invention may be implemented or applied by means of other different specific embodiments, and based on different points of view and applications, various modifications or variations may be made to the details provided here without departing from the spirit of the invention. It should be noted that the following embodiment and features in the following embodiment may be combined without conflicts.

It should be noted that drawings provided in the following embodiment are merely used to schematically explain the basic concept of the invention, only components related to the invention are shown in the drawings, the components are not drawn according to the number, shape and size of components in actual implementation, the form, number and proportion of the components may be changed freely in actual implementation, and the overall arrangement of the components may be more complex.

### Embodiment 1

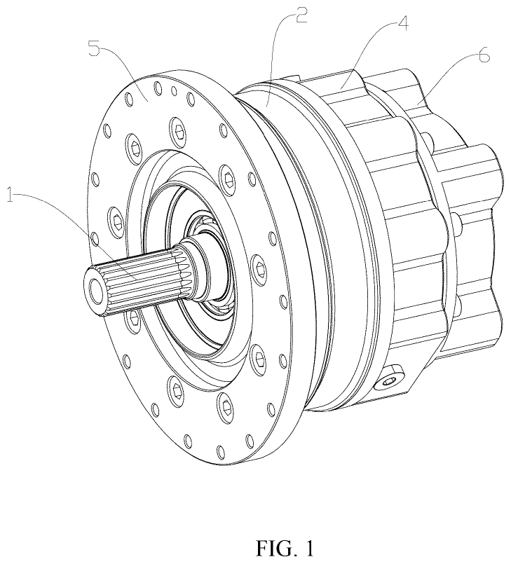

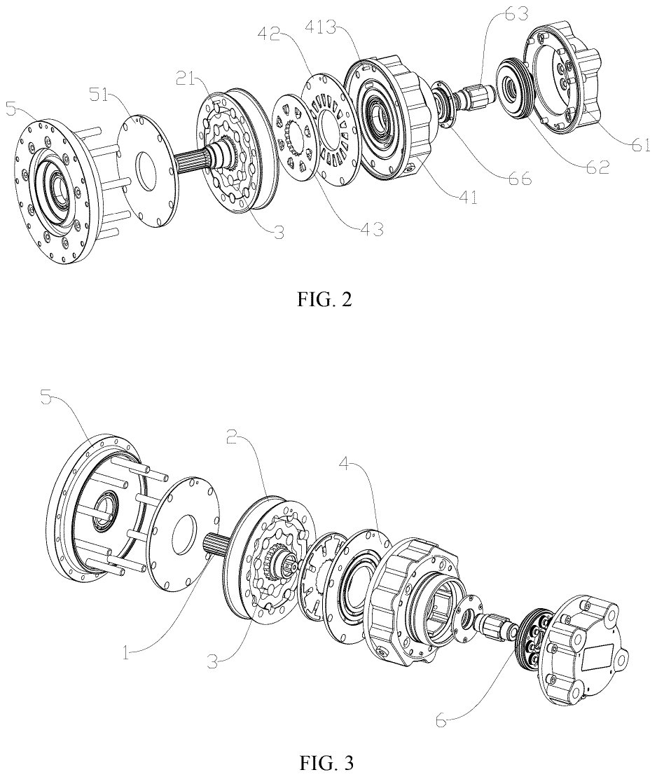

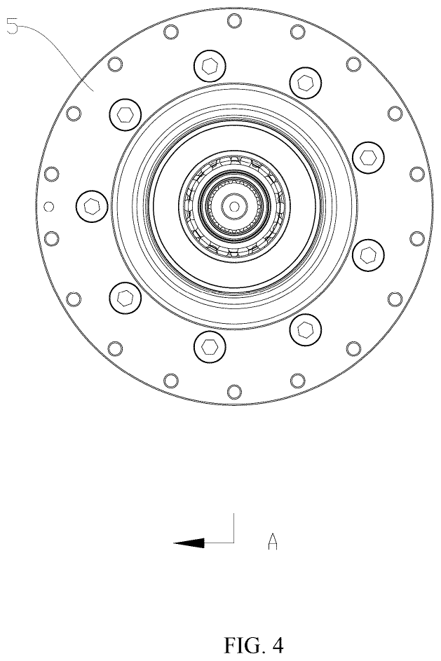

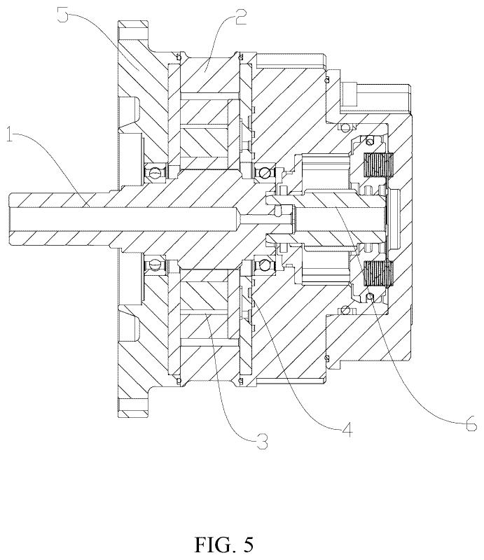

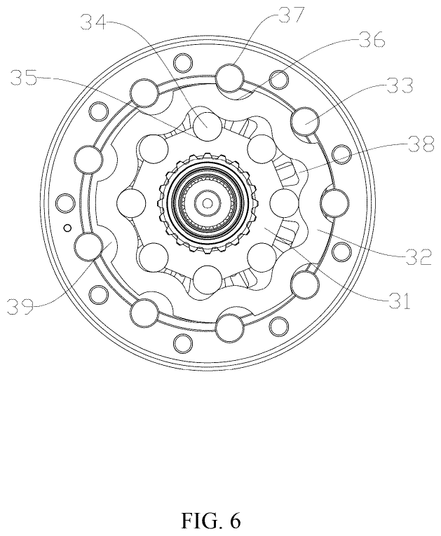

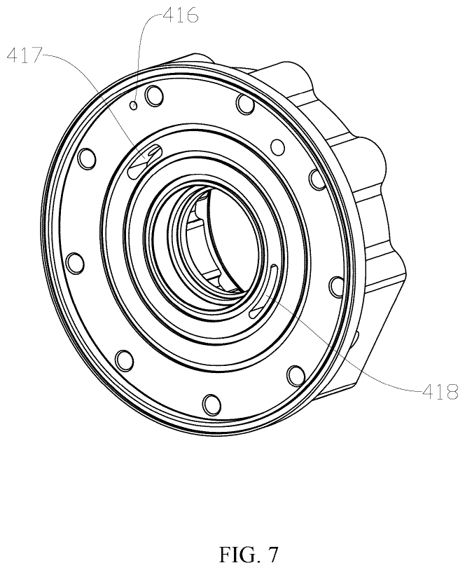

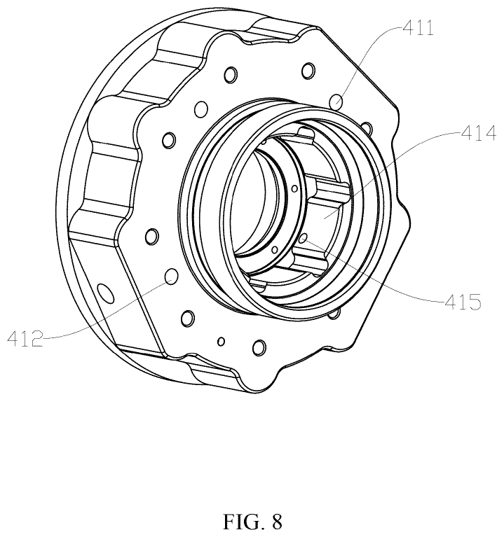

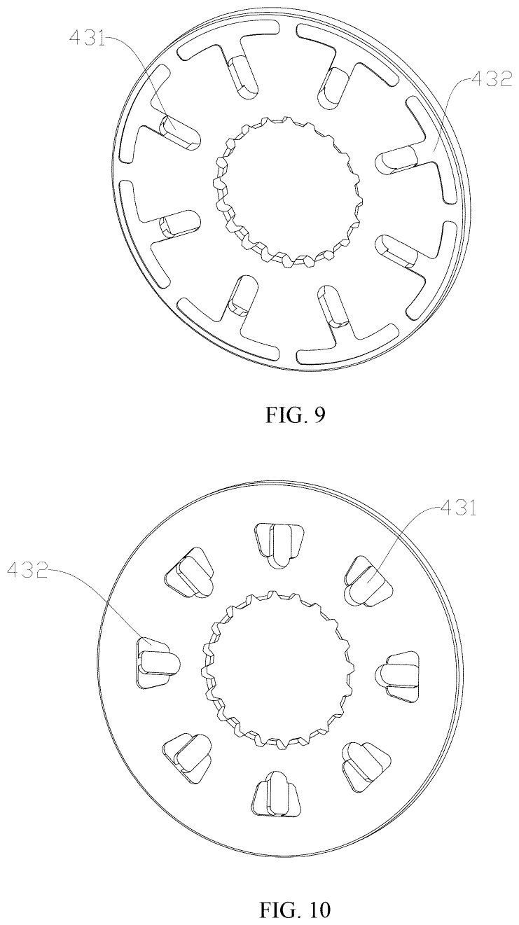

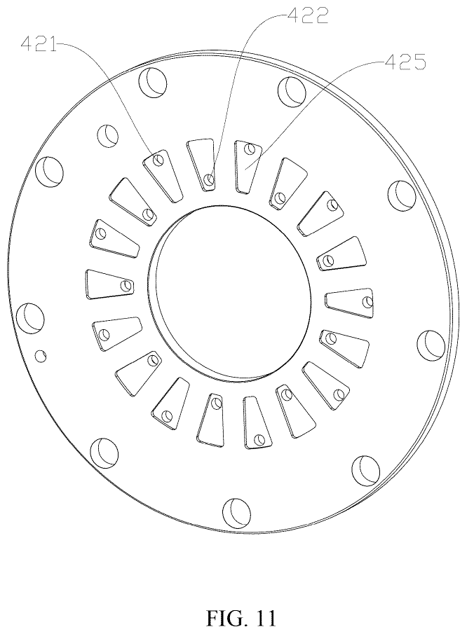

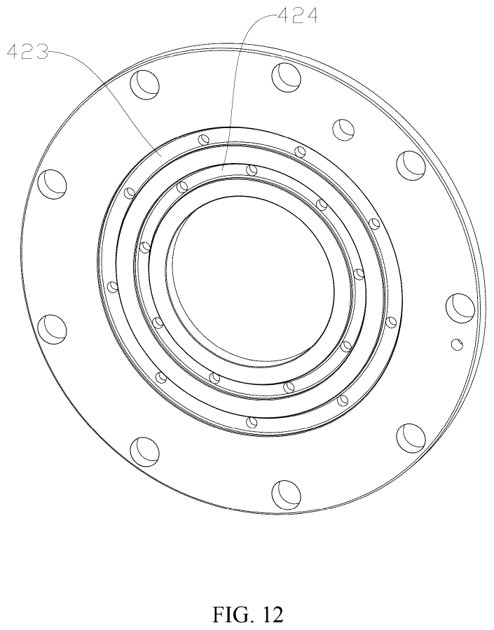

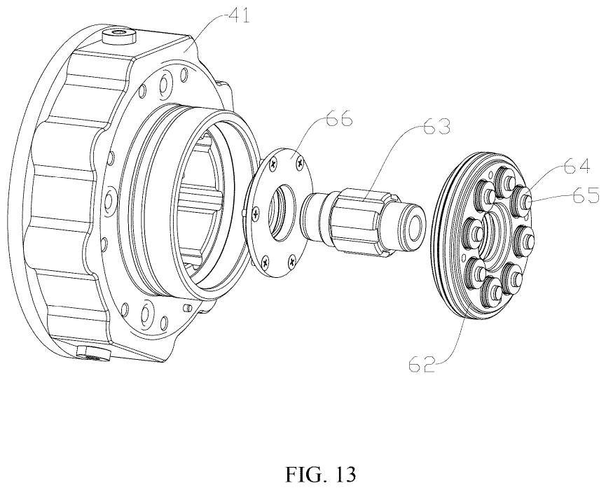

As shown in FIGS. 1-13, a floating male-rotor hypocycloidal motor includes an output shaft 1 and a housing 2. The output shaft 1 is arranged in the housing 2, and one end of the output shaft 1 stretches out of the housing 2. The floating male-rotor hypocycloidal motor further includes a hypocycloidal structure 3 and an oil supply structure 4. The hypocycloidal structure 3 includes a rotor 31, a floating stator 32, outer rollers 33 and inner rollers 34. The rotor 31 is in transmission connection with the output shaft 1 and used for driving the output shaft 1 to rotate, and a plurality of first grooves 35 matched with inner rollers 34 are formed in an outer side of the rotor 31 and allow the inner rollers 34 to be inlaid therein. The floating stator 32 is located on the outer side of the rotor 31. The floating stator 32 is ring-shaped on the whole, up-and-down arc surfaces based on a cycloidal contour are arranged on an inner side of the floating stator 32, and a cylindrical surface is arranged on an outer side of the floating stator 32. In this embodiment, eight inner rollers 34 are arranged on the outer side of the rotor 31, and nine arc surfaces, which are up and down alternately, are arranged on the floating stator 32. Second grooves 36 corresponding to the outer rollers 33 are formed in the outer side of the floating stator 32. The housing is located on an outer side of the hypocycloidal structure, third grooves 37 matched with the outer rollers 33 are formed in a side, close to the hypocycloidal structure, of the housing 2, and the outer rollers 33 are inlaid in the third grooves 37. In this embodiment, the first grooves and the third grooves are all arc grooves that fit outer surfaces of the corresponding rollers, the second grooves are also arc grooves, and the width of the second grooves is greater than the sectional diameter of the outer rollers. In this embodiment, nine outer rollers 33 are arranged between the housing 2 and the floating stator 32. A minimum inner diameter of the floating stator 32 is greater than an outer diameter of the rotor 31, and a first gap 38 is formed between the floating stator 32 and the rotor 31. It should be noted that a minimum internal length of the floating stator 32 penetrating through an axis is greater than a maximum external length of the rotor 31, combined with the inner rollers 34, penetrating through the axis, such that when the floating stator 32 deflects, the inner rollers 34 will be pushed to drive the rotor 31 to rotate. A maximum outer diameter of the floating stator 32 is less than an inner diameter of the housing 2, such that a second gap 39 is formed between the floating stator 32 and the housing 2. It should be noted that a maximum external length of the floating stator 32 penetrating through the axis is greater than a minimum internal length of the housing 2, combined with the outer rollers 33, penetrating through the axis, such that on one hand, it is ensured that the outer rollers 33 are kept inlaid in the corresponding third grooves 37 in the housing 2; on the other hand, the floating stator 32, when moving, will deflect slightly and will not rotate by a large angle. The oil supply structure 4 corresponds to the first gap 38 and is used for supplying oil into the first gap 38 and pumping oil from the first gap 38. When oil is supplied into the first gap 38, the hydraulic pressure of a portion to which oil is supplied will be increased, and the hydraulic pressure of a portion from which oil is pumped is decreased, such that the floating stator 32 is driven to deflect; and when the floating stator 32 deflects, the inner rollers 34 will be pushed to drive the rotor 31 to rotate, and the output shaft 1 output a torque.

The oil supply structure 4 includes a rear end cover 41, an oil distribution disc 42 and an oil inlet and outlet disc 43. First oil holes 421 and second oil holes 422 are formed in the oil distribution disc 42 and penetrate through the oil distribution disc 42, and the first oil holes 421 and the second oil holes 422 are respectively located on circular trajectories, with different radii, on the oil distribution disc 42. The first oil holes 421 and the second oil holes 422 in the oil distribution disc 42 are arranged alternately. Oil flows in via the first oil holes 421 and flows out via the second oil holes 422, or oil flows in via the second oil holes 422 and flows out via the first oil holes 421. In a case where oil flows in via the first oil holes 421, the motor rotates forward. In a case where oil flows in via the second oil holes 422, the motor rotates reversely. In this embodiment, oil flows in via the first oil holes 421 and flows out via the second oil holes 422. A first oil groove 423 corresponding to the first oil holes 421 and a second oil groove 424 corresponding to the second oil holes 422 are formed in a side, close to the rear end cover 41, of the oil distribution disc 42, all the first oil holes 421 are connected to the first oil groove 423, and all the second oil holes 422 are connected to the second oil groove 424. A side wall adjacent to the first oil groove 423 and the second oil groove 424 is arranged between the first oil groove 423 and the second oil groove 424, and the side wall is next to the rear end cover 41 and isolates the first oil groove 423 from the second oil groove 424. The oil distribution disc 42 is fixed and attached to the rear end cover 41, a first passage 411 and a second passage 412 are formed in the rear end cover 41, and the first passage 411 and the second passage 412 respectively correspond to the first oil groove 423 and the second oil groove 424 in the oil distribution disc 42. In this embodiment, a first arc hole 417 corresponding to the first oil groove 423 in the oil distribution disc 42 in shape is formed in a side, close to the oil distribution disc 42, of the first passage 411 in the rear end cover 41; similarly, a second arc hole 418 corresponding to the second oil groove 424 in shape is formed in a side, close to the oil distribution disc 42, of the second passage 412. Under the condition where the diameter of circular holes is limited, the arc holes may improve the capacity to quickly fill oil into or pump oil from the first oil groove 423 and the second oil groove 424 respectively. The angle between the first passage 411 and the second passage 412 in the rear end cover 41 is 180°.

The oil inlet and outlet disc 43 is attached to the floating stator 32, and the first gap 38 between the floating stator 32 and the rotor 31 is sealed. The oil inlet and outlet disc 43 is in transmission connection with the rotor 31 or the output shaft 1. In this embodiment, the oil inlet and outlet disc 43 is in engaged transmission with the output shaft 1, such that the oil inlet and outlet disc 43 rotates with the rotation of the output shaft 1. Oil inlet and outlet holes 431, the number of which corresponds to the number of the inner rollers 34, are formed in the oil inlet and outlet disc 43, and each of the oil inlet and outlet holes 431 is located between two adjacent inner rollers 34 and connected to the first gap 38. In this embodiment, the number of the inner rollers 34 is eight, and eight corresponding oil inlet and outlet holes 431 are formed in the oil inlet and outlet disc 43. The oil inlet and outlet holes 431 are kidney-shaped holes, such that when the oil inlet and outlet disc 43 rotates with respect to the oil distribution disc 42, the oil inlet and outlet holes 431 in oil inlet and outlet disc 43 are sequentially connected to the first oil holes 421 and the second oil holes 422 located on circular trajectories, with different diameters, on the oil distribution disc 42.

The number of the first oil holes 421 formed in the oil distribution disc 42 and the number of the second oil holes 422 formed in the oil distribution disc 42 are greater than the number of the inner rollers 34. In this embodiment, nine first oil holes 421 distributed at equal angles and nine second oil holes 422 distributed at equal angles are arranged on the oil distribution disc 42, such that the oil inlet and outlet holes 431 in the oil inlet and outlet disc 42 will not be all connected to the first oil holes 421 or the second oil holes 422 in the oil distribution disc 42 at the same time; instead, some of oil inlet and outlet holes 431 are connected to the first oil holes 421 in the oil distribution disc 42, some of the oil inlet and outlet holes 431 are connected to the second oil holes 422, and the remaining oil inlet and outlet holes 421 are sealed and blocked by portions, not provided with the first oil holes 421 and the second oil holes 422, of the oil distribution disc 42. In addition, because the first oil holes and the second oil holes are alternately arranged at equal angles, the oil inlet and outlet holes 431 connected to the first oil holes 421 and the oil inlet and outlet holes 431 connected to the second oil holes 422 are distributed continuously, and a hydraulic pressure difference is formed between different oil inlet and outlet holes 431 in the oil inlet and outlet disc 43 to push the floating stator 32 to deflect. Wherein, in the movement process, first, hydraulic oil enters the first oil groove 423 via the first passage 411 in the rear end cover 41 and is stored in the first oil groove 423; with the rotation of the rotor 31 and the oil inlet and outlet disc 43, the oil inlet and outlet holes 431 in the oil inlet and outlet disc 43 are sequentially connected to the first oil holes 421 and the second oil holes 422 in the oil distribution disc 42, the hydraulic oil flows into the first gap 38 via the first oil holes 421, and the hydraulic oil on the other side of the first gap 38 enters the second oil groove 424 via the second oil holes 422 and then flows out via the second passage 412 in the rear end cover 41 to realize circulation. It should be noted that in some other embodiments, hydraulic oil may flow reversely along the oil path, and in this case, the motor rotates reversely.

Oil distribution cavities 425 which are concaved downward are formed in sides, close to the oil inlet and outlet disc 43, of the first oil holes 421 and the second oil holes 422 in the oil distribution disc 42, and the sectional area of tops of the oil distribution cavities 425 is greater than the sectional area of the first oil holes 421 or the second oil holes 422. On one hand, the oil distribution cavities 425 may be easily connected to the oil inlet and outlet holes 431 in the oil inlet and outlet disc 43, that is, when the oil inlet and outlet disc 43 rotates with respect to the oil distribution disc 42, the oil distribution cavities 425 may be connected to the oil inlet and outlet holes 431 within a greater angle range; on the other hand, a certain quantity of hydraulic oil may be stored in the oil distribution cavities 425, such that when the oil distribution cavities 425 are connected to the oil inlet and outlet holes 431 in the oil inlet and outlet disc 43, hydraulic oil may be filled into the first gap 38 quickly via the oil inlet and outlet holes 431.

Concaved oil storage cavities 432 are respectively formed in two ends of the oil inlet and outlet holes 431 in the oil inlet and outlet disc 43 and connected to the oil inlet and outlet holes 431. It should be noted that the oil storage cavities 432 are not synchronously connected to two adjacent first oil holes 421 or second oil holes 422 or the oil distribution cavities 425 of two adjacent first oil holes 421 or two adjacent second oil holes 422.

The radius of the circular trajectory, where the first oil holes 421 are located, on the oil distribution disc 42 is greater than the radius of the circular trajectory, where the second oil holes 422 are located, on the oil distribution disc 42. In some other embodiments, the radius of the circular trajectory, where the first oil holes 421 are located, on the oil distribution disc 42 may be less than the radius of the circular trajectory, where the second oil holes 422 are located, on the oil distribution disc 42. The radius of the circular trajectory where the first oil holes 421 are located is set to be different from the radius of the circular trajectory where the second oil holes 422 are located, such that the first oil groove 423 is isolated from the second oil groove 424.

An oil supply hole 416 corresponding to the second gap 39 and used for lubricating the outer rollers is formed in the rear end cover 41, and the oil supply hole 416 penetrates through a through-hole formed in the oil distribution disc 42 to be connected into the second gap 39 to pump hydraulic oil into the second gap 39, such that the frictional resistance generated when the floating stator 32 deflects is reduced.

It should be noted that the oil inlet and outlet direction of the rear end cover and the oil distribution disc may be changed.

The floating male-rotor hypocycloidal motor further includes a front end cover 5. The front end cover 5 is fixedly connected to the housing 2 by means of long screws, and a front abrasion-resistant disc 51 used for sealing is fixedly arranged between the front end cover 5 and the housing 2. A first positioning pin 413 used for determining a matching angle between the oil distribution disc 42 and the rear end cover 41 is arranged between the oil distribution disc 42 and the rear end cover 41, and second positioning pins 21 used for determining matching angles are arranged between the housing 2 and the front abrasion-resistant disc 51 as well as between the housing 2 and the front end cover 5.

The rotor 31 and the output shaft 1 are in engaged transmission by means of a tooth structure 11, and the tooth structure 11 on the output shaft 1 is in engaged transmission with the oil inlet and outlet disc 43 to drive the oil inlet and outlet disc 43 to rotate. Two ends of the rotor 31 are rotatably connected to the front end cover 5 and the rear end cover 41 respectively, and ball bearings are respectively arranged between the rotor 31 and the front end cover 5 as well as between the rotor 31 and the rear end cover 41.

The floating male-rotor hypocycloidal motor further includes a brake structure 6. The brake structure 6 includes a brake cover 61, a brake piston 62 and a brake shaft 63. One end of the brake shaft 63 penetrates through a central hole of the rear end cover 41 to be in transmission connection with the output shaft 1, and the brake shaft 63 seals the central hole of the rear end cover 41. In this embodiment, an end, close to the brake shaft 63, of the output shaft 1 is shaped like a regular hexagonal prism, a corresponding hexagonal hole is formed in an end, close to the output shaft 1, of the brake shaft 63, and the regular hexagonal prism is inserted into the hexagonal hole to connect the output shaft 1 and the brake shaft 63 to realize synchronous rotation. The other end of the brake shaft 63 penetrates into a brake hole 621 in the middle of the brake piston 62 and seals the brake piston 62. A plurality of protruding brake blocks are arranged on the periphery of the brake shaft 63 and abut against an edge of the brake hole 621 of the brake piston 62. The brake cover 61 is fixedly connected to the rear end cover 41, and a plurality of disc springs 64 are arranged between the brake cover 61 and the brake piston 62. The disc springs 64 are disposed around brake pillars 65. In this embodiment, a plurality of brake pillars 65 are arranged around the axis of the brake piston 64 at equal angles, and a plurality of disc springs 64 are disposed around each brake pillar 65. The brake piston 62 is slidably arranged in a columnar cavity 414 in the rear end cover 41, and a brake oil hole 415 used for supplying and pumping oil is formed in the columnar cavity 414. Wherein, when oil supplied into the brake oil hole 415 reaches a certain pressure, the brake piston 62 in the sealed columnar cavity 414 will be pushed towards the brake cover 61 to reduce the rotational resistance applied to the brake shaft 63 by the brake piston 62. When the pressure of oil supplied into the brake oil hole 415 is decreased, the brake piston 62 will be pushed towards the brake shaft 63 under the action of the disc springs 64 between the brake piston 62 and the brake cover 61 and abut against the brake blocks on the periphery of the brake shaft 63 to improve the rotational resistance between the brake piston 62 and the brake shaft 63, thus stopping the brake shaft 63.

It should be noted that to guarantee the sealing effect between the brake shaft 63 and the rear end cover 41, a brake compression ring 66 is arranged between the central hole of the rear end cover 41 and the brake shaft 63. The brake compression ring 66 is fixedly connected to the bottom of the columnar cavity 414 of the rear end cover 41 by means of a threaded structure, the brake shaft 63 penetrates through the elastic brake compression ring 66, and a sealing ring used for sealing is arranged between the periphery of the brake shaft 63 and an inner wall of the brake compression ring 66. A third positioning pin used for determining a matching angle between the brake cover 61 and the rear end cover 41 is arranged between the brake cover 61 and the rear end cover 41.

An external passage connected to the first passage 411, the second passage 412, the oil supply hole 416 and the brake oil hole 415 is formed in an outer surface of the rear end cover 41, a screw used for sealing is arranged on an outer side of the external passage, and the screw may be detached for maintenance or other operations.

In the implementation process, the floating stator 32 is arranged and works together with the inner rollers 34, the outer rollers 33, the rotor 31 and the oil supply structure 4 to change the oil pressure distribution in the first gap 38, such that the floating stator 32 is driven to deflect and swing to drive the rotor 31 therein to rotate so as to control the output shaft 1 to rotate to output a large torque; the oil distribution disc 42 and the oil inlet and outlet disc 43 are arranged to supply oil into the first gap 38 and pump oil from the first oil gap 38 to control the oil pressure distribution in the first gap 38 so as to control the rotor 31 to rotate; in addition, the floating stator deflects eccentrically to allow the rotor therein to move around the axis, such that structures such as a sensor and a reducer may be easily integrated at a shaft end for the rotor and the output shaft; the brake structure 6 is arranged and works together with the brake oil hole 415 to control the relative pressure between the brake piston 62 and the brake shaft 63 to adjust the brake force and even control the brake shaft 63 and the output shaft 1 to stop; and the oil distribution cavities 425 are arranged, on one hand, the oil distribution cavities 425 may be easily connected to the oil inlet and outlet holes 431 in the oil inlet and outlet disc 43 within a greater angle range; on the other hand, a certain quantity of hydraulic oil may be stored in the oil distribution cavities 425, such that when the oil distribution cavities 425 are connected to the oil inlet and outlet holes 431 in the oil inlet and outlet disc 43, hydraulic oil may be quickly filled into the first gap 38 by means of the oil inlet and outlet holes 431, thus increasing the rotational speed and torque output by the output shaft 1.

One specific example of the invention is described above, and the above example is not intended to limit the invention in any form. Obviously, for those skilled in the art, various amendments and modifications may be made in form and details with reference to the contents and principle of the invention without departing from the principle of the invention, and all these amendments and modifications based on the concept of the invention should also fall within the protection scope of the claims of the invention.

What is claimed is:

1. A floating male-rotor hypocycloidal motor, comprising an output shaft and a housing, the output shaft being arranged in the housing and having an end stretching out of the housing, wherein the floating male-rotor hypocycloidal motor further comprises a hypocycloidal structure and an oil supply structure; the hypocycloidal structure comprises a rotor, a floating stator, outer rollers and inner rollers; the rotor is in transmission connection with the output shaft and used for driving the output shaft to rotate, and a plurality of first grooves matched with the inner rollers are formed in an outer side of the rotor and allow the inner rollers to be inlaid therein; the floating stator is located on the outer side of the rotor; the floating stator is ring-shaped on the whole, up-and-down arc surfaces based on a cycloidal contour are arranged on an inner side of the floating stator, a cylindrical surface is arranged on an outer side of the floating stator, and second grooves corresponding to the outer rollers are formed in the outer side of the floating stator; the housing is located on an outer side of the hypocycloidal structure, third grooves matched with the outer rollers are formed in a side, close to the hypocycloidal structure, of the housing, and the outer rollers are inlaid in the third grooves; a minimum inner diameter of the floating stator is greater than an outer diameter of the rotor, and a first gap is formed between the floating stator and the rotor; a maximum outer diameter of the floating stator is less than an inner diameter of the housing, and a second gap is formed between the floating stator and the housing; and the oil supply structure corresponds to the first gap and is used for supplying oil into the first gap and pumping oil from the first gap.

2. The floating male-rotor hypocycloidal motor according to claim 1, wherein the oil supply structure comprises a rear end cover, an oil distribution disc and an oil inlet and outlet disc; first oil holes and second oil holes are formed in the oil distribution disc and penetrate through the oil distribution disc, and the first oil holes and the second oil holes are respectively located on circular trajectories, with different radii, on the oil distribution disc; the first oil holes and the second oil holes in the oil distribution disc are arranged alternately; a first oil groove corresponding to the first oil holes and a second oil groove corresponding to the second oil holes are formed in a side, close to the rear end cover, of the oil distribution disc, all the first oil holes are connected to the first oil groove, and all the second oil holes are connected to the second oil groove; the oil distribution disc is fixed and attached to the rear end cover, a first passage and a second passage are formed in the rear end cover, and the first passage and the second passage respectively correspond to the first oil groove and the second oil groove in the oil distribution disc; the oil inlet and outlet disc is attached to the floating stator and is in transmission connection with the rotor or the output shaft; oil inlet and outlet holes, the number of which corresponds to the number of the inner rollers, are formed in the oil inlet and outlet disc, and each of the oil inlet and outlet holes is located between two adjacent said inner rollers; and when the oil inlet and outlet disc rotates with respect to the oil distribution disc, the oil inlet and outlet holes in the oil inlet and outlet disc are sequentially connected to the first oil holes and the second oil holes in the oil distribution disc.

3. The floating male-rotor hypocycloidal motor according to claim 2, wherein oil distribution cavities which are concaved downward are formed in sides, close to the oil inlet and outlet disc, of the first oil holes and the second oil holes in the oil distribution disc.

4. The floating male-rotor hypocycloidal motor according to claim 2, wherein the number of the first oil holes formed in the oil distribution disc and the number of the second oil holes formed in the oil distribution disc are greater than the number of the inner rollers.

5. The floating male-rotor hypocycloidal motor according to claim 2, wherein oil storage cavities are respectively formed in two ends of the oil inlet and outlet holes in the oil inlet and outlet disc, and the oil storage cavities are connected to the oil inlet and outlet holes.

6. The floating male-rotor hypocycloidal motor according to claim 2, wherein a first positioning pin used for determining a matching angle between the oil distribution disc and the rear end cover is arranged between the oil distribution disc and the rear end cover.

7. The floating male-rotor hypocycloidal motor according to claim 2, further comprising a front end cover, wherein the front end cover is fixedly connected to the housing by means of long screws, and a front abrasion-resistant disc used for sealing is fixedly arranged between the front end cover and the housing.

8. The floating male-rotor hypocycloidal motor according to claim 7, wherein second positioning pins used for determining matching angles are arranged between the housing and the front abrasion-resistant disc as well as between the housing and the front end cover.

9. The floating male-rotor hypocycloidal motor according to claim 2, further comprising a brake structure, wherein the brake structure comprises a brake cover, a brake piston and a brake shaft, one end of the brake shaft penetrates through a central hole of the rear end cover to be in transmission connection with the output shaft, and the brake shaft seals the central hole of the rear end cover; the other end of the brake shaft penetrates into a brake hole in a middle of the brake piston and seals the brake piston; a plurality of protruding brake blocks are arranged on a periphery of the brake shaft and abut against an edge of the brake hole of the brake piston; the brake cover is fixedly connected to the rear end cover, and a plurality of disc springs are arranged between the brake cover and the brake piston; and the brake piston is slidably arranged in a columnar cavity in the rear end cover, and a brake oil hole used for supplying and pumping oil is formed in the columnar cavity.

10. The floating male-rotor hypocycloidal motor according to claim 2, wherein an oil supply hole corresponding to the second gap and used for lubricating the outer rollers is formed in the rear end cover.
